(19) United States
(12) Patent Application Publication
(10) Pub. No.: US 2003/0079178 A1
(43) Pub. Date: Apr. 24, 2003

(54) METHOD AND SYSTEM FOR EFFICIENTLY CONSTRUCTING AND CONSISTENTLY PUBLISHING WEB DOCUMENTS

(76) Inventors: JAMES R. H. CHALLENGER, GARRISON, NY (US); CAMERON FERSTAT, SLEEPY HOLLOW, NY (US); ARUN K. IYENGAR, YORKTOWN HEIGHTS, NY (US); PAUL REED, HARRISON, NY (US); KAREN A. WITTING, OSSINING, NY (US)

Correspondence Address: FRANK CHAU, F CHAU & ASSOCIATES, 1900 HEMPSTEAD TURNPIKE, SUITE 501, EAST MEADOW, NY, 11554

(21) Appl. No.: 09/283,561

(22) Filed: Apr. 1, 1999

(51) Int. Cl. G06F 15/00

(52) U.S. Cl. 715/501.1

(57) ABSTRACT

A method, which may be implemented by employing a program storage device, for determining an order in which to construct objects, in accordance with the present invention, includes the steps of providing a plurality of objects, at least one of the objects including a relationship with another object in the plurality of objects, identifying at least one relationship between the plurality of objects, representing the at least one relationship between the plurality of objects using at least one graph, and traversing at least one graph to determine the order in which to construct objects in accordance with the at least one relationship and an update to at least one of the objects in the plurality of objects.

### BACKGROUND OF THE INVENTION

1. Field of the Invention

The present invention relates to computerized publication of documents, and more particularly to a method for efficiently constructing and consistently publishing documents on the World Wide Web.

2. Description of the Related Art

Web sites often present content which is constantly changing. Presenting consistent information to the outside world without requiring an inordinate amount of computing power is a major technical challenge to Web site designers.

Some of the key consistency constraints for publishing Web pages include the following:

(1) A newly updated Web page should not contain hypertext links to older pages which have not been updated yet.

(2) A newly updated Web page should not contain hypertext links to pages which have not been created yet.

(3) In many cases, a Web site should not have some of the pages reflecting current information while other pages reflect older information. Instead, it is desirable to publish all updated pages containing current information in one atomic action.

Therefore, a need exists for a system and method for efficiently constructing documents which provides the capability for updating the documents in accordance with changes in a consistent and atomic matter.

### SUMMARY OF THE INVENTION

A method, which may be implemented by employing a program storage device, for determining an order in which to construct objects, in accordance with the present invention, includes the steps of providing a plurality of objects, at least one of the objects including a relationship with another object in the plurality of objects, identifying at least one relationship between the plurality of objects, representing the at least one relationship between the plurality of objects using at least one graph, and traversing at least one graph to determine the order in which to construct objects in accordance with the at least one relationship and an update to at least one of the objects in the plurality of objects.

In alternate methods, the step of representing the at least one relationship between the plurality of objects may include the step of representing objects in the plurality of objects by nodes and representing the at least one relationship by at least one connection between nodes. The step of traversing at least one graph to determine the order may include the step of selecting the order based on one of performance and correct construction of the plurality of objects. The step of traversing at least one graph to determine the order may include the step of traversing by employing at least one topological sort on the at least one graph. The order may be constructed from the at least one topological sort. The step of constructing objects may be based on the order. The step of publishing at least one of the plurality of objects may be included. All of the at least one of the plurality of objects may be published together. The step of publishing may include the steps of partitioning the at least one of the plurality of objects into a plurality of groups and publishing all objects belonging to a same group together.

In still other methods, the step of publishing all objects belonging to a same group together may include the step of, for at least two of the plurality of groups, publishing all objects belonging to a first group before publishing any objects belonging to a second group. The step of publishing may include the step of satisfying at least one consistency constraint. The step of satisfying at least one consistency constraint may include the step of delaying publication of a first object until a second object which is referenced by the first object is published. The first object and the second object may include Web pages and a reference between the first and second objects may include a hypertext link. The step of satisfying at least one consistency constraint may include the step of publishing two compound objects together if the compound objects are both constructed from at least one common changed fragment. At least one of the plurality of objects is preferably a Web page.

A method, which may be implemented by employing a program storage device, for publishing a plurality of objects includes the steps of providing a plurality of objects, including compound objects, partitioning at least some of the plurality of objects into a plurality of groups such that if two compound objects are constructed from at least one common changed fragment, then the compound objects are placed in a same group, and publishing all objects belonging to a same group together.

In alternate embodiments, the step of publishing may include the step of, for at least two of the plurality of groups, publishing all objects belonging to a first group before publishing any objects belonging to a second group. The step of publishing may include the step of delaying publication of a first object until a second object which is referenced by the first object is published. The first and the second objects may be Web pages and a reference between the first and the second objects may be a hypertext link. The steps of representing objects by nodes on at least one graph and representing relationships between the objects by connections between the nodes may be included. The connections may include an edge between two nodes representing compound objects if the two compound objects are constructed from at least one common changed fragment. The connections may include a directed edge from a first node representing a first object to a second node representing a second object, if the second object includes a reference to the first object. The steps of determining if a first compound object and a second compound object embed at least one common changed fragment by topologically sorting at least part of a graph including dependence edges between objects, determining changed fragments needed to construct a first object by examining the graph in an order defined by the topological sort and constructing a union between a second object and changed fragments needed to construct the second object for at least one edge which begins with the second object and terminates in the first object and for which the second object has changed.

In still other methods, the step of performing a topological sort on at least part of the at least one graph for finding strongly connected components may be included. The steps of examining objects in an order defined by the topological sort, when an unpublished object is examined, publishing the unpublished object together with all objects belonging to a same strongly connected component may also be included.

Another method, which may be implemented by employing a program storage device, for publishing a plurality of objects includes the steps of providing a plurality of objects, constructing at least one graph, the at least one graph including nodes representing objects and edges for connecting nodes having relationships, at least some of the edges being derived from at least one consistency constraint, and finding at least one strongly connected component in the at least one graph.

In alternate embodiments, the step of publishing a set of objects belonging to a same strongly connected component group may be included. The step of topologically sorting at least part of the at least one graph may also be included. The steps of examining objects in an order defined by topological sorting, when an unpublished object is examined, publishing the unpublished object together with all objects belonging to a same strongly connected component may be included. The at least one consistency constraint may include delaying publication of a first object before a second object which is referenced by the first object is published. The objects may include Web pages and at least one edge between the objects may correspond to at least one hypertext link. An edge may exist from a first object to a second object in at least one of the at least one graphs if the second object has a reference to the first object. At least one of the consistency constraints may include publishing two compound objects together if the two compound objects are both constructed from at least one common changed fragment.

These and other objects, features and advantages of the present invention will become apparent from the following detailed description of illustrative embodiments thereof, which is to be read in connection with the accompanying drawings.

### BRIEF DESCRIPTION OF DRAWINGS

The invention will be described in detail in the following description of preferred embodiments with reference to the following figures wherein:

FIG. 1 is a block diagram showing relationships among a set of fragments and compound objects.

FIG. 2 is a block/flow diagram of a system/method for efficiently constructing and publishing objects in accordance with the present invention;

FIG. 3 is a block diagram showing a relationship between a set of fragments and compound objects in accordance with the present invention;

FIG. 4 is an object dependence graph (ODG) corresponding according to FIG. 3, in accordance with the present invention; and

FIG. 5 is a flow diagram for a method for consistently publishing objects in accordance with the present invention.

### DETAILED DESCRIPTION OF PREFERRED EMBODIMENTS

This invention presents a system and method for publishing documents, for example Web documents, efficiently and consistently. This method may be used at a wide variety of Web sites of the World Wide Web. The present invention may be applied to systems outside the Web as well, for example, where compound objects are constructed from fragments. A fragment is an object which is used to construct a compound object. An object is an entity which can either be published or is used to create something which is publishable. Objects include both fragments and compound objects. A compound object is an object constructed from one or more fragments.

In generating Web content, publishable Web pages known as servables may be constructed from simpler fragments. A servable is a complete entity which may be published at a Web site. Publishing an object means making it visible to the public or a community of users. Publishing is decoupled from creating or updating an object and generally takes place after the object has been created or updated. It is possible for a servable to embed a fragment which in turn embeds another fragment, etc.

While fragments significantly increase the capabilities of a Web site, a number of problems may arise which need to be solved, including the following:

(1) When changes to underlying data occur, how does the system determine all objects affected by the change?

(2) How does the system determine a correct and efficient order for updating fragments and servables?

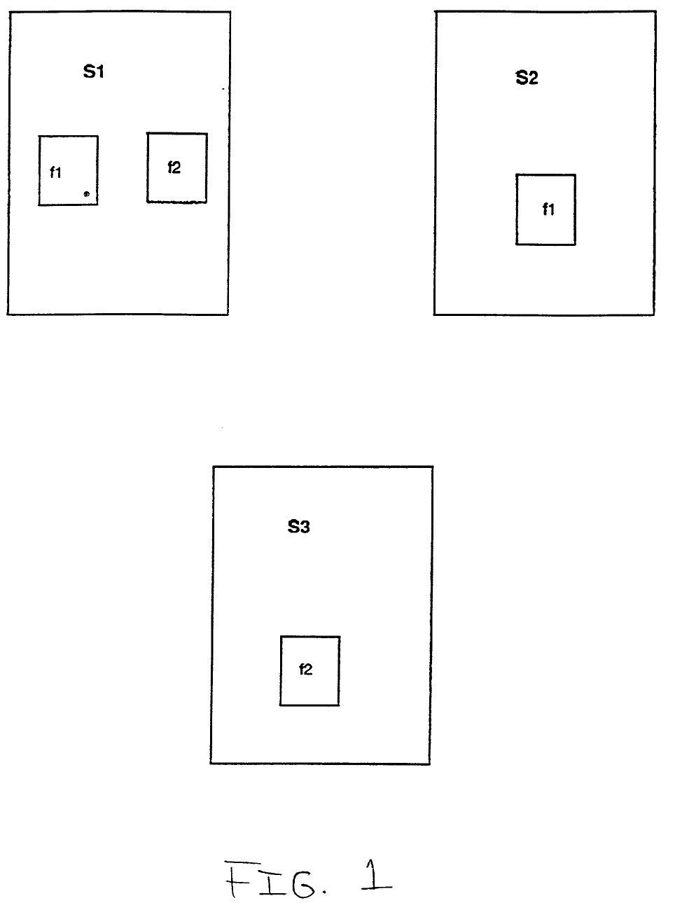

(3) How can a system consistently publish Web pages in the presence of fragments? For an illustrative example, refer to FIG. 1. Suppose that servables S1 and S2 both embed the same fragment f1. If f1 changes, updated versions of S1 and S2 must be published concurrently; otherwise, the site will look inconsistent. However, the consistency problem is worse than just determining if a set of pages all embed the same fragment. For example, suppose S1 and S3 both embed fragment f2. If f2 changes, updated versions of both S1 and S3 must be published concurrently. However, if both f1 and f2 change, updated versions of S1, S2, and S3 must be published concurrently, even though S2 and S3 might not embed a common fragment.

A method for solving problem (1) is described in a commonly assigned patent application, U.S. Ser. No. 08/905,114, entitled “Determining How Changes to Underlying Data Affect Cached Objects” by J. Challenger, P. Dantzig, A. Iyengar, and G. Spivak. The current invention solves problems (2) and (3).

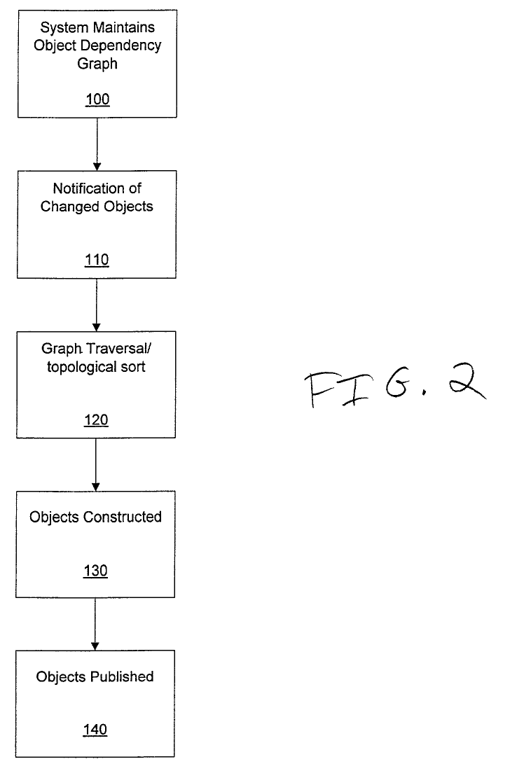

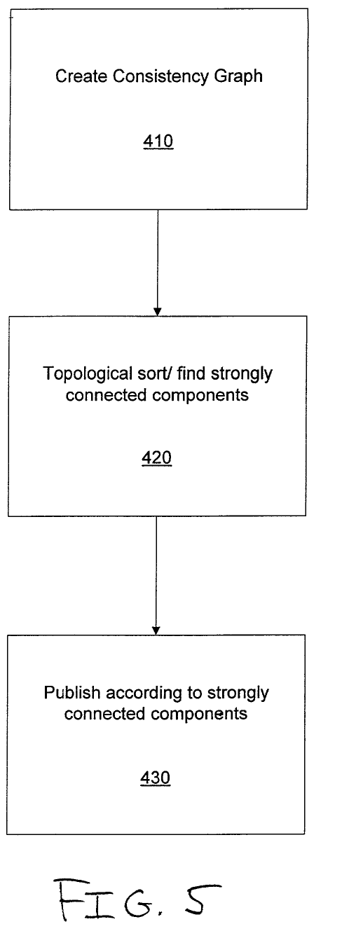

It should be understood that the elements shown in FIGS. 2 and 5 may be implemented in various forms of hardware, software or combinations thereof unless otherwise specified. Preferably, these elements are implemented in software on one or more appropriately programmed general purpose digital computers having a processor and memory and input/output interfaces. Referring now to the drawings in which like numerals represent the same or similar elements and initially to FIG. 2, a block/flow diagram of a system/method for efficiently constructing and publishing one or more servables in accordance with the present invention is shown. In block 100, the system maintains an object dependence graph (ODG) which is a directed graph with objects corresponding to nodes/vertices in the graph. A dependence edge from a to b, for example, indicates that a change to object a also affects object b. The edge also implies that a should be updated before b after a change which affects the values of both a and b occurs.

Dependence edges may preferably be used to identify the following:

a. The objects affected by a change to underlying data.

b. The order in which objects are desired or needed to be updated.

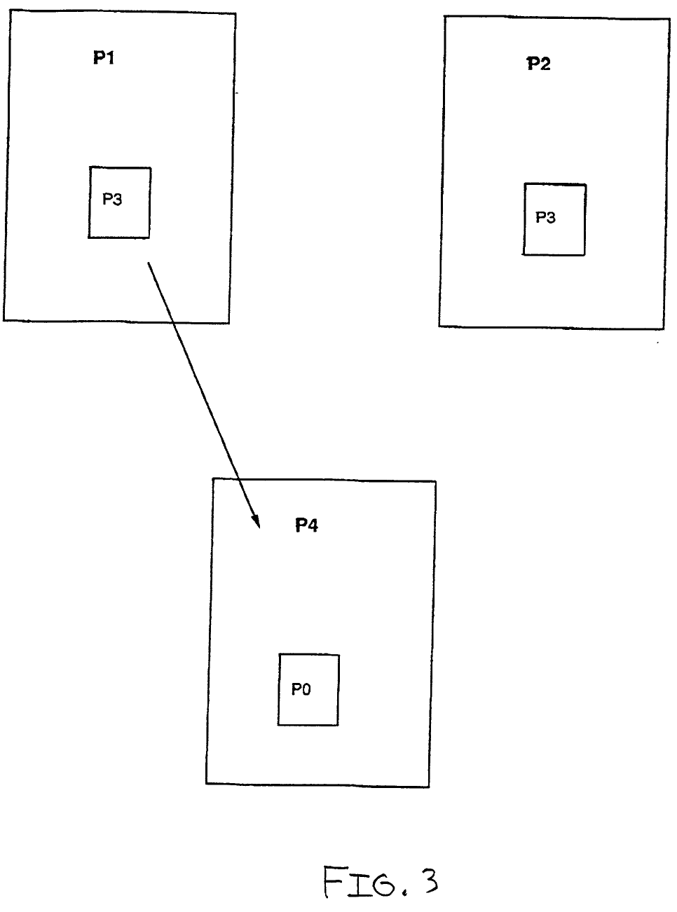

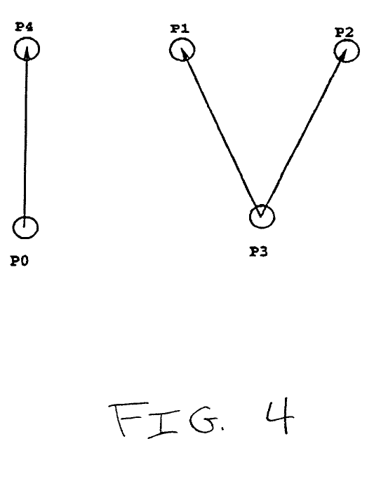

In one illustrative example, FIG. 3 depicts 3 Web pages, P1, P2, and P4. P3 is a fragment embedded in P1 and P2. Similarly, P0 is a fragment embedded in P4. An arrow “A” from P1 to P4 indicates that P1 has a hypertext link to P4. In the illustrative example, FIG. 4 depicts an object dependence graph (ODG) corresponding to the objects in FIG. 3. The ODG indicates that any change to P0 also changes the value of P4. It also indicates that any change to P3 also changes both P1 and P2. Since P4 includes P0, P0 should be constructed before P4 when P0 changes. Similarly, P3 should be updated before both P1 and P2 when P3 changes.

Whenever objects change, the system is notified in block 110. The system will be notified of a set of objects C which have changed. Changes to objects in C will often imply changes to other objects as well; the system applies graph traversal algorithms to detect all objects which have changed and an efficient order (or partial order) for computing changed objects. In block 120, a set of all objects S affected by the change is determined by a topological sort (or partial sort) of all (or some) nodes reachable from C by following edges in the ODG. Topological sorting of S orders the vertices so that whenever there is a path from a to b, a appears before b. A topological sorting algorithm is presented in Introduction to Algorithms by Cormen, Leiserson, and Rivest, MIT Press, 1990, Cambridge, Mass., incorporated herein by reference. Other topological algorithms may also be employed.

In block 130, objects in S are updated in an order consistent with the topological sort performed in block 120. In block 140, objects are published. In one method, all servables are published in S concurrently. This avoids consistency problems. Another method publishes some servables in S before others, i.e. incremental publication. There are a number of reasons why incremental publication may be desirable. These reasons may include:

(1) In a number of environments, publishing documents after the documents are updated may be time-consuming. Incremental publication may make certain documents available sooner than would be the case using the all-at-once approach.

(2) It is conceivable that some environments may have constraints on the number of documents which can be published atomically. The incremental approach reduces the number of documents which need to be published in single atomic actions.

Incremental publishing may be more difficult to implement than the all-at-once approach because of the need to satisfy consistency constraints such as the ones described earlier.

Referring to FIG. 5, a method for incrementally publishing objects, for example, Web pages, which satisfies one or more consistency constraints described earlier is shown. In step 410, a consistency graph is created which includes servables as vertices/nodes. Edges of the consistency graph are referred to as consistency edges. A consistency edge from a servable c to another servable d indicates that d should not be published before c. Consistency edges do not imply the order in which c and d are be generated. A consistency edge exists if there were a hypertext link from d to c and both d and c are in S. Such a link does not imply that c must be constructed before d, only that c should be published before or concurrently with d. It is entirely possible that data dependence edges indicate that d should be constructed before c even though c should be published before or at the same time as d.

Consistency edges are also used to indicate that two servables both embed a common fragment whose value has changed and thus are to be published concurrently. If c and d both embed a common fragment whose value has changed, then a consistency edge from c to d and d to c should exist.

It is now explained how to determine whether two servables both embed a common changed fragment. As a node a in S is constructed in the order defined by the topological sort in block 130, a set of comprising-nodes is computed for a. Comprising-nodes(a) includes identifiers for nodes in S which affect the value of a. Comprising-nodes(a) is the union of b and comprising-nodes(b) for edges (b, a) which terminate in a where b is a member of S.

A directed graph T is now created including servables in S (S is the set of all objects which have changed) and consistency edges. For two servables a and b in S, an edge from a to b exists in T if:

(1) A hypertext link from b to a exists, or

(2) a and b both embed a common changed fragment. This is true if comprising-nodes(a) and comprising-nodes(b) have a node in common. In this case, a consistency edge from both a to b and b to a exist.

In step 420, graph traversal algorithms are used on T to topologically sort T and find its strongly connected components. A strongly connected component of T is a maximal subset of vertices T′ such that every vertex in T′ has a directed path to every other vertex in T′. The previously cited book, Introduction to Algorithms, by Cormen, et al. includes an algorithm for finding strongly connected components. Other algorithms for finding strongly connected components may also be employed. Each strongly connected component of T corresponds to a set of servables which can be published together.

In step 430, servables are published in the following order: Examine servables of T in topological sorting order. For a servable a of T, if a was part of a previously published strongly connected component, go to the next servable. Otherwise, publish all servables corresponding to the strongly connected component including a in an atomic action.

An extension of this algorithm may be to use either more or fewer consistency constraints in the method depicted in FIG. 5. Another extension may be to enhance the method to try to prevent publication of pages with broken hypertext links. The present invention may be extended to the publication of documents including but not limited to Web pages.

A quick publishing and censoring system and method which may be used is described in “METHOD AND SYSTEM FOR RAPID PUBLISHING AND CENSORING INFORMATION”, Attorney docket number YO999-040(8728-253), filed concurrently herewith, commonly assigned and incorporated herein by reference. A system and method which may be used for publishing web documents is described in “METHOD AND SYSTEM FOR PUBLISHING DYNAMIC WEB DOCUMENTS”, Attorney docket number YO999-039(8728-254), filed concurrently herewith, commonly assigned and incorporated herein by reference.

Having described preferred embodiments of a system and method for efficiently constructing and consistently publishing web documents (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A method for determining an order in which to construct objects comprising the steps of:
providing a plurality of objects, at least one of the objects including a relationship with another object in the plurality of objects;
identifying at least one relationship between the plurality of objects;
representing the at least one relationship between the plurality of objects using at least one graph; and
traversing at least one graph to determine the order in which to construct objects in accordance with the at least one relationship and an update to at least one of the objects in the plurality of objects.

2. The method as recited in claim 1, wherein the step of representing the at least one relationship between the plurality of objects includes the step of representing objects in the plurality of objects by nodes and representing the at least one relationship by at least one connection between nodes.

3. The method as recited in claim 1, wherein the step of traversing at least one graph to determine the order includes the step of selecting the order based on one of performance and correct construction of the plurality of objects.

4. The method as recited in claim 1, wherein the step of traversing at least one graph to determine the order includes the step of traversing by employing at least one topological sort on the at least one graph.

5. The method as recited in claim 4, wherein the order is constructed from the at least one topological sort.

6. The method as recited in claim 1, further comprising the step of constructing objects based on the order.

7. The method as recited in claim 1, further comprising the step of publishing at least one of the plurality of objects.

8. The method as recited in claim 7, wherein all of the at least one of the plurality of objects are published together.

9. The method as recited in claim 7, wherein the step of publishing includes the steps of:
partitioning the at least one of the plurality of objects into a plurality of groups; and
publishing all objects belonging to a same group together.

10. The method as recited in claim 9 wherein the step of publishing all objects belonging to a same group together includes the step of:
for at least two of the plurality of groups, publishing all objects belonging to a first group before publishing any objects belonging to a second group.

11. The method as recited in claim 7, wherein the step of publishing includes the step of satisfying at least one consistency constraint.

12. The method as recited in claim 11, wherein the step of satisfying at least one consistency constraint includes the step of delaying publication of a first object until a second object which is referenced by the first object is published.

13. The method as recited in claim 12, wherein the first object and the second object include Web pages and a reference between the first and second objects includes a hypertext link.

14. The method as recited in claim 11, wherein the step of satisfying at least one consistency constraint includes the step of publishing two compound objects together if the compound objects are both constructed from at least one common changed fragment.

15. The method as recited in claim 1, wherein at least one of the plurality of objects is a Web page.

16. A method for publishing a plurality of objects comprising the steps of:
providing a plurality of objects, including compound objects;
partitioning at least some of the plurality of objects into a plurality of groups such that if two compound objects are constructed from at least one common changed fragment, then the compound objects are placed in a same group; and
publishing all objects belonging to a same group together.

17. The method as recited in claim 16, wherein the step of publishing includes the step of:
for at least two of the plurality of groups, publishing all objects belonging to a first group before publishing any objects belonging to a second group.

18. The method as recited in claim 16, wherein the step of publishing includes the step of:
delaying publication of a first object until a second object which is referenced by the first object is published.

19. The method as recited in claim 18, wherein the first and the second objects are Web pages and a reference between the first and the second objects is a hypertext link.

20. The method as recited in claim 16, further comprising the steps of:
representing objects by nodes on at least one graph; and
representing relationships between the objects by connections between the nodes.

21. The method as recited in claim 20, wherein the connections include an edge between two nodes representing compound objects if the two compound objects are constructed from at least one common changed fragment.

22. The method as recited in claim 20, wherein the connections include a directed edge from a first node representing a first object to a second node representing a second object, if the second object includes a reference to the first object.

23. The method of claim 20, further comprising the steps of:
determining if a first compound object and a second compound object embed at least one common changed fragment by:
topologically sorting at least part of a graph including dependence edges between objects;
determining changed fragments needed to construct a first object by:
examining the graph in an order defined by the topological sort; and
constructing a union between a second object and changed fragments needed to construct the second object for at least one edge which begins with the second object and terminates in the first object and for which the second object has changed.

24. The method as recited in claim 20 further comprising the step of performing a topological sort on at least part of the at least one graph for finding strongly connected components.

25. The method as recited in claim 24, further comprising the step of publishing a set objects belonging to a same strongly connected component, of the at least one graph, together.

26. The method as recited in claim 24, further comprising the steps of:
examining objects in an order defined by the topological sort;
when an unpublished object is examined, publishing the unpublished object together with all objects belonging to a same strongly connected component.

27. A program storage device readable by machine, tangibly embodying a program of instructions executable by the machine to perform method steps for determining an order in which to construct a plurality of objects, the method steps comprising:
providing a plurality of objects, at least one of the objects including a relationship with another object in the plurality of objects;
identifying at least one relationship between the plurality of objects;
representing the plurality of objects and the at least one relationship between the plurality of objects using at least one graph; and
traversing at least one graph to determine the order in which to construct objects in accordance with the at least one relationship and an update to at least one of the objects in the plurality of objects.

28. The program storage device as recited in claim 27, wherein the step of graphically representing the at least one relationship between the plurality of objects includes the step of representing objects in the plurality of objects by a node and representing the at least one relationship by a connection between nodes.

29. The program storage device as recited in claim 27, wherein the step of traversing at least one graph to determine the order includes the step of selecting the order based on one of performance and correct construction of the plurality of objects.

30. The program storage device as recited in claim 27, wherein the step of traversing at least one graph to determine the order includes the step of traversing by employing at least one topological sort on at least part of the at least one graph.

31. The program storage device as recited in claim 30, wherein the order is constructed from the at least one topological sort.

32. The program storage device as recited in claim 27, further comprising the step of constructing the plurality of objects based on the order.

33. The program storage device as recited in claim 27, further comprising the step of publishing at least one of the plurality of objects.

34. The program storage device as recited in claim 33, wherein all of the at least one of the plurality of objects are published together.

35. The program storage device as recited in claim 33, wherein the step of publishing includes the steps of:
partitioning the at least one of the plurality of objects into a plurality of groups; and
publishing all objects belonging to a same group together.

36. The program storage device as recited in claim 35 wherein the step of publishing all objects belonging to a same group together includes the step of:
for at least two of the plurality of groups, publishing all objects belonging to a first group before publishing any objects belonging to a second group.

37. The program storage device as recited in claim 33, wherein the step of publishing includes the step of satisfying at least one consistency constraint.

38. The program storage device as recited in claim 37, wherein the step of satisfying at least one consistency constraint includes the step of delaying publication of a first object until a second object which is referenced by the first object is published.

39. The program storage device as recited in claim 38, wherein the first object and the second object include Web pages and a reference between the first and second objects includes a hypertext link.

40. The program storage device as recited in claim 37, wherein the step of satisfying at least one consistency constraint includes the step of publishing two compound objects together if the compound objects are both constructed from at least one common changed fragment.

41. The program storage device as recited in claim 27, wherein at least one of the plurality of objects is a Web page.

42. A program storage device readable by machine, tangibly embodying a program of instructions executable by the machine to perform method steps for publishing a plurality of objects, the method steps comprising:
providing a plurality of objects, including compound objects;
partitioning at least some of the plurality of objects into a plurality of groups such that if two compound objects are constructed from at least one common changed fragment, then the compound objects are placed in a same group; and
publishing all objects belonging to a same group together.

43. The program storage device as recited in claim 42, wherein the step of publishing includes the step of:
for at least two of the plurality of groups, publishing all objects belonging to a first group before publishing any objects belonging to a second group.

44. The program storage device as recited in claim 42, wherein the step of publishing includes the step of:
delaying publication of a first object until a second object which is referenced by the first object is published.

45. The program storage device as recited in claim 44, wherein the first and the second objects are Web pages and a reference between the first and second objects is a hypertext link.

46. The program storage device as recited in claim 44, further comprising the steps of:
representing objects by nodes on at least one graph; and
representing relationships between the objects by connections between the nodes.

47. The program storage device as recited in claim 46, wherein the connections include an edge between two nodes representing compound objects if two compound objects are constructed from at least one common changed fragment.

48. The program storage device as recited in claim 46, wherein the connections include a directed edge from a first node representing a first object to a second node representing a second object, if the second object includes a reference to the first object.

49. The program storage device of claim 46, further comprising the steps of:
determining if a first compound object and a second compound object embed at least one common changed fragment by:
topologically sorting a graph including dependence edges between objects;
determining changed fragments needed to construct a first object by:
examining the graph in an order defined by the topological sort; and
constructing a union between a second object and changed fragments needed to construct the second object for at least one edge which begins with the second object and terminates in the first object and for which the second object has changed.

50. The program storage device as recited in claim 46, further comprising the step of performing a topological sort on at least part of the at least one graph for finding strongly connected components.

51. The program storage device as recited in claim 50, further comprising the step of publishing a set objects belonging to a same strongly connected component, of the at least one graph, together.

52. The method as recited in claim 50, further comprising the steps of:
examining objects in an order defined by the topological sort;
when an unpublished object is examined, publishing the unpublished object together with all objects belonging to a same strongly connected component.

53. A method for publishing a plurality of objects comprising the steps of:
providing a plurality of objects;
constructing at least one graph, the at least one graph including nodes representing objects and edges for connecting nodes having relationships, at least some of the edges being derived from at least one consistency constraint; and
finding at least one strongly connected component in the at least one graph.

54. The method as recited in claim 53, further comprising the step of publishing a set of objects belonging to a same strongly connected component group.

55. The method as recited in claim 53, further comprising the step of topologically sorting at least part of the at least one graph.

56. The method as recited in claim 55, further comprising the steps of:
examining objects in an order defined by topological sorting;
when an unpublished object is examined, publishing the unpublished object together with all objects belonging to a same strongly connected component.

57. The method as recited in claim 53, wherein one of the at least one consistency constraint includes delaying of a first object before a second object which is referenced by the first object is published.

58. The method as recited in claim 57, wherein the first and second objects include Web pages and at least one edge between the objects corresponds to at least one hypertext link.

59. The method as recited in claim 53, wherein an edge exists from a first object to a second object in at least one of the at least one graphs if the second object has a reference to the first object.

60. The method as recited in claim 53, wherein at least one of the consistency constraints includes publishing two compound objects together if the two compound objects are both constructed from at least one common changed fragment.
